(19) United States
(12) Patent Application Publication
(10) Pub. No.: US 2007/0212580 A1
(43) Pub. Date: Sep. 13, 2007

(54) Hybrid power supply device

(75) Inventors: Kazuhiro Seo, Hirakata-City (JP); Masaya Fujii, Takatsuki-City (JP)

Correspondence Address: NDQ&M WATCHSTONE LLP, 1300 EYE STREET, NW, SUITE 1000 WEST TOWER, WASHINGTON, DC, 20005, US

(73) Assignee: SANYO ELECTRIC CO., LTD., Moriguchi City (JP)

(21) Appl. No.: 11/715,402

(22) Filed: Mar. 8, 2007

(30) Foreign Application Priority Data
Mar. 13, 2006 (JP) JP2006-067284

(51) Int. Cl. H01M 8/04

(52) U.S. Cl. 429/22; 429/23

(57) ABSTRACT

A hybrid power supply device is provided with a fuel cell, an electric storage device that is connected in parallel to the fuel cell via a switch, and a control circuit that controls connection between output terminals of the fuel cell and the electric storage device by controlling on/off of the switch. Here, the control circuit controls the connection between the output terminals based on an output current of the fuel cell, and disconnects the output terminals when the output current of the fuel cell becomes equal to or smaller than a predetermined lower limit current while the output terminals are connected.

This application is based on Japanese Patent Application No. 2006-067284 filed on Mar. 13, 2006, the contents of which are hereby incorporated by reference.

### BACKGROUND OF THE INVENTION

1. Field of the Invention

The present invention relates to a hybrid power supply device that uses both a fuel cell and an electric storage device such as a rechargeable battery.

2. Description of Related Art

In a hybrid power supply device that uses both a fuel cell and a rechargeable battery, in general, a diode is provided as a blocking circuit between the fuel cell and the rechargeable battery to protect the fuel cell. However, needless to say, the diode thus provided consumes additional electric power, and thus makes it difficult to improve the efficiency of the power supply device.

To overcome this inconvenience, a configuration in which a fuel cell is connected in parallel to a rechargeable battery via a switch has been proposed. For example, such a configuration is disclosed in JP-A-2004-342551 and JP-A-H08-163711. Here, a fuel cell is connected in parallel to a rechargeable battery via a switch. This helps reduce electric power consumption of a diode, and reduce the output voltage of the fuel cell by the voltage drop across the diode.

Incidentally, operating a fuel cell within an unstable operating region results in the degradation in characteristics, for example. Thus, even in a case where a fuel cell is connected in parallel to a rechargeable battery via a switch, it is necessary to use a technique that prevents the fuel cell from operating within an unstable operating region.

### SUMMARY OF THE INVENTION

According to the present invention, a first hybrid power supply device is provided with a fuel cell, an electric storage device that is connected in parallel to the fuel cell via a switch, and a control circuit that controls connection between output terminals of the fuel cell and the electric storage device by controlling on/off of the switch. Here, the control circuit controls the connection between the output terminals based on an output current of the fuel cell, and disconnects the output terminals when the output current of the fuel cell becomes equal to or smaller than a predetermined lower limit current while the output terminals are connected.

Preferably, for example, there is further provided a voltage detector that detects an output voltage of the electric storage device, and the lower limit current is determined in accordance with the output voltage of the electric storage device.

Preferably, for example, there is further provided a replenishment detecting portion that detects whether the fuel cell is replenished with fuel or not. When fuel replenishment is detected after the output terminals are disconnected as a result of the output current of the fuel cell becoming equal to or smaller than the lower limit current, the control circuit restores the connection between the output terminals.

Preferably, for example, the hybrid power supply device is so configured that a fuel cell unit built with the fuel cell and fuel for the fuel cell can be replaced, and the hybrid power supply device is further provided with a replacement detecting portion that detects whether the fuel cell unit is replaced or not. When replacement of the fuel cell unit is detected after the output terminals are disconnected as a result of the output current of the fuel cell becoming equal to or smaller than the lower limit current, the control circuit restores the connection between the output terminals.

Preferably, for example, there is further provided a voltage detector that detects an output voltage of the electric storage device, and the control circuit disconnects the output terminals when the detected output voltage becomes equal to or higher than a predetermined first voltage while the output terminals are connected.

Preferably, for example, there is further provided a voltage detector that detects an output voltage of the electric storage device. When the detected output voltage becomes equal to or higher than a predetermined first voltage while the output terminals are connected, the control circuit disconnects the output terminals, and then, when the detected output voltage becomes equal to or lower than a predetermined second voltage that is lower than the first voltage, the control circuit restores the connection between the output terminals.

According to the present invention, a second hybrid power supply device is provided with a fuel cell, an electric storage device that is connected in parallel to the fuel cell via a switch, a control circuit that controls connection between output terminals of the fuel cell and the electric storage device by controlling on/off of the switch, and a voltage detector that detects an output voltage of the electric storage device. When the detected output voltage becomes equal to or higher than a predetermined first voltage while the output terminals are connected, the control circuit disconnects the output terminals, and then, when the detected output voltage becomes equal to or lower than a predetermined second voltage that is lower than the first voltage, the control circuit restores the connection between the output terminals.

### BRIEF DESCRIPTION OF THE DRAWINGS

FIG. 1 is a block configuration diagram of the hybrid power supply device (the power supply device) according to an embodiment of the present invention;

FIG. 2 is a configuration diagram schematically showing one single cell that is a component of the fuel cell shown in FIG. 1;

FIG. 3 is a graph showing the output characteristics of the fuel cell shown in FIG. 1;

FIG. 4 is a graph showing a stable operating region and an unstable operating region of the fuel cell shown in FIG. 1;

FIG. 5 is a graph showing how the output characteristics of the fuel cell shown in FIG. 1 change as the fuel concentration changes;

FIG. 6 is a graph illustrating the operation of the control circuit shown in FIG. 1;

FIG. 7 is a diagram schematically showing how the fuel cartridge shown in FIG. 2 is replaced;

FIG. 8 is a diagram showing an example of the internal configuration of the control circuit shown in FIG. 1;

FIG. 9 is a diagram illustrating the operation of the control circuit shown in FIG. 1;

FIG. 10 is a diagram showing the internal configuration of the control circuit shown in FIG. 1; and

FIG. 11 is a diagram illustrating a method of restoring the fuel concentration of the fuel cell shown in FIG. 1.

### DETAILED DESCRIPTION OF PREFERRED EMBODIMENTS

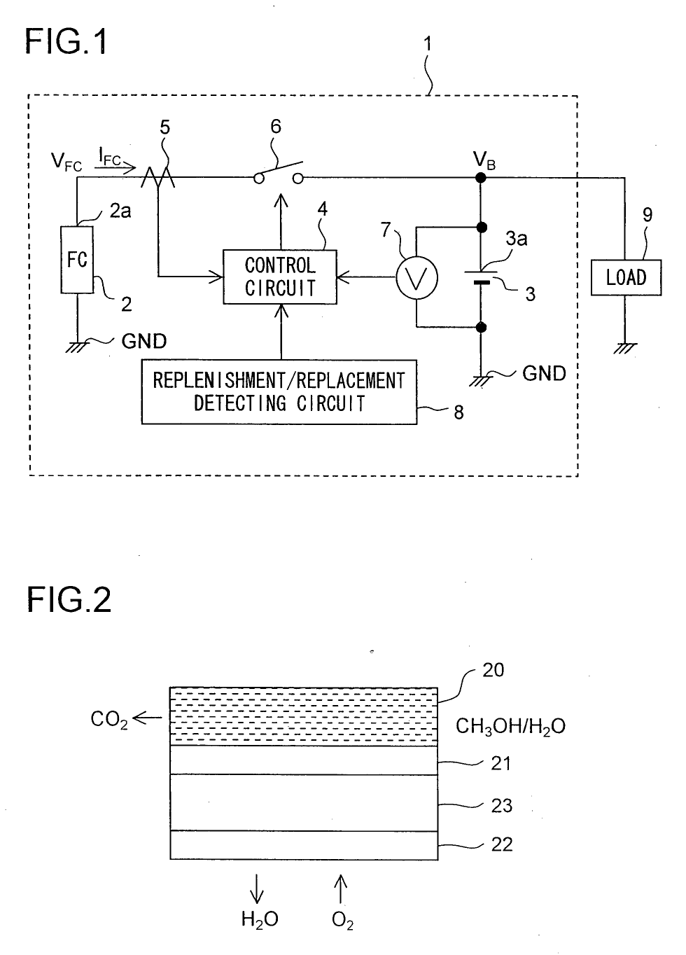

Hereinafter, an embodiment of the present invention will be specifically described with reference to the accompanying drawings. It is to be noted that such components as are common to these drawings are identified with the same reference characters. FIG. 1 shows a block configuration diagram of a hybrid power supply device 1 (hereinafter also referred to simply as the “power supply device 1”) according to an embodiment of the present invention.

The power supply device 1 is composed of a fuel cell 2, a rechargeable battery 3 that functions as an electric storage device, a control circuit 4, a current detector 5, a switch 6, a voltage detector 7, and a replenishment/replacement detecting circuit 8. A load 9 is connected to the power supply device 1.

The fuel cell 2 is a direct methanol fuel cell that generates electric power by using the fuel, methanol, that is fed directly thereto. It is to be noted that a fuel cell of a type other than a direct methanol fuel cell may be adopted as the fuel cell 2.

The fuel cell 2 consists of a plurality of single cells that are connected in series. In FIG. 2, a configuration diagram schematically showing one single cell that is a component of the fuel cell 2 is shown. One single cell is composed of a fuel electrode 21 supporting an electrode catalyst that promotes oxidation of methanol, an oxygen electrode 22 supporting an electrode catalyst that promotes the reduction reaction of oxygen, and a solid polymer electrolyte membrane 23 that is sandwiched between the fuel electrode 21 and the oxygen electrode 22.

The fuel, methanol diluted with water, is stored in a fuel cartridge 20. Methanol inside the fuel cartridge 20 is directly fed to the fuel electrode 21. The oxygen electrode 22 is in contact with air.

At the fuel electrode 21, methanol reacts with water and forms carbon dioxide, hydrogen ions, and electrons (CH₃OH+H₂O→CO₂+6H⁺+6e⁻). The hydrogen ions pass through the solid polymer electrolyte membrane 23 and then reach the oxygen electrode 22, and the electrons pass through an external circuit (such as a load) and then reach the oxygen electrode 22. At the oxygen electrode 22, the hydrogen ions meet up oxygen in the air and combine therewith to form water by removing electrons on the surface of the electrode ( 3/2. O₂+6H⁺+6e⁻→3H₂O). Incidentally, the carbon dioxide formed at the fuel electrode 21 and water formed at the oxygen electrode 22 are discharged via an unillustrated outlet.

The fuel cell 2 is formed as an assembled battery in which the single cells shown in FIG. 2 are connected in series. A negative electrode (fuel electrode 21) of a single cell located on the lowest voltage side is connected to a ground line GND having a reference potential (0V). A voltage of a positive electrode (oxygen electrode 22) of a single cell located on the highest voltage side is outputted to the load 9 as an output voltage of the fuel cell 2. Hereinafter, the output voltage of the fuel cell 2 is referred to as a voltage V_{FC}, and the output current of the fuel cell 2 is referred to as a current I_{FC}.

A positive output terminal 2a of the fuel cell 2, at which the voltage V_{FC} appears, is connected to one end of the switch 6 via the current detector 5. The other end of the switch 6 is connected to a positive output terminal (positive electrode) 3a of the rechargeable battery 3 and to the load 9. A negative output terminal (negative electrode) of the rechargeable battery 3 is connected to the ground line GND.

The current detector 5 detects a current value of the current I_{FC}. The detection result of the current I_{FC} (more precisely, the current value of the current I_{FC}) is transmitted to the control circuit 4. The voltage detector 7 detects a voltage value of an output voltage (hereinafter referred to as a voltage V_{B}) of the rechargeable battery 3. The detection result of the voltage V_{B} (more precisely, the voltage value of the voltage V_{B}) is transmitted to the control circuit 4.

Based on the detection result of the current I_{FC}, the detection result of the voltage V_{B}, and, what the replenishment/replacement detecting circuit 8 detects will be described later, the detection result of the replenishment/replacement detecting circuit 8, the control circuit 4 controls on/off of the switch 6.

The switch 6 is built as an FET (field effect transistor), for example, and one conducting electrode thereof (for example, a drain) is connected to the output terminal 2a of the fuel cell 2 via the current detector 5; the other conducting electrode thereof (for example, a source) is connected to the output terminal 3a of the rechargeable battery 3. The switch 6 is controlled by the control circuit 4 so as to electrically connect or disconnect the output terminal 2a and the output terminal 3a. Hereinafter, a state of the switch 6 in which the output terminal 2a and the output terminal 3a are electrically connected is referred to as “on”, and a state of the switch 6 in which the output terminal 2a and the output terminal 3a are electrically disconnected is referred to as “off”.

An specific example of the rechargeable battery 3 is a lithium-ion rechargeable battery. It is to be noted, however, that a rechargeable battery of any other type may be adopted as the rechargeable battery 3.

When the switch 6 is on, naturally the voltage V_{FC} and the voltage V_{B} are equal to each other. Thus, it is necessary to set an open-circuit output voltage of the fuel cell 2 so as to be equal to or higher than the voltage V_{B}. Preferably, the number of single cells connected in series to form the fuel cell 2 is determined so that the voltage V_{FC} becomes equal (or substantially equal) to the voltage V_{B} at a desired operating point of the fuel cell 2. For example, in a case where a voltage generated by one single cell is 0.4 V and the output voltage of the lithium-ion rechargeable battery is around 4 V, the ideal number of single cells connected in series is 10.

The load 9 is, for example, a portable device such as a mobile telephone or a portable information terminal. From another viewpoint, it can be said that the load 9 and the power supply device 1 form together a portable device. When the switch 6 is on, the fuel cell 2 and the rechargeable battery 3 cooperate to feed electric power to the load 9; when the switch 6 is off, the rechargeable battery 3 alone feeds electric power to the load 9.

Generally, in a hybrid power supply device using both a fuel cell and a rechargeable battery, one of them serves as a master and the other serves as a slave so as to drive a load. In the power supply device 1 shown in FIG. 1, a master/slave relationship between the fuel cell 2 and the rechargeable battery 3 can be arbitrarily changed according to the load 9.

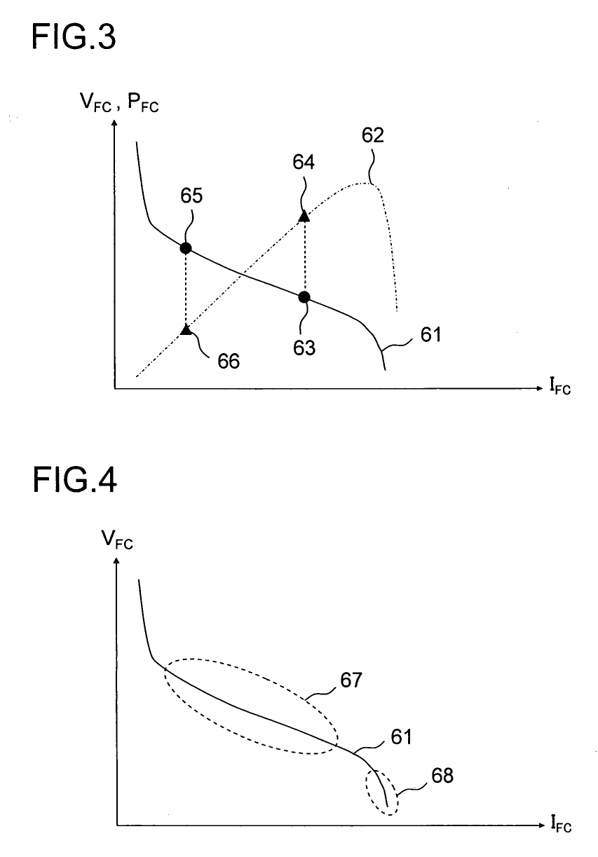

FIG. 3 shows the output characteristics of the fuel cell 2. A curve 61 indicates a relationship between the current I_{FC} and the voltage V_{FC} under a given fuel concentration condition. A curve 62 indicates a relationship between the current I_{FC} and an output electric power P_{FC} of the fuel cell 2 under a given fuel concentration condition. In this embodiment, the fuel concentration means the concentration of the fuel fed to the fuel electrode 21 of the fuel cell 2.

As will be understood from the curve 61, in the same fuel concentration, the voltage V_{FC} decreases with an increase in the current I_{FC}. On the other hand, as will be understood from the curve 62, in the same fuel concentration, the output electric power P_{FC} increases with an increase in the current I_{FC}. However, the output electric power P_{FC} becomes maximum at a given current I_{FC}, and a further increase in the current I_{FC} causes drastic decrease in the output electric power P_{FC}.

When the voltage V_{B} becomes relatively low due to a small electric capacity of the rechargeable battery 3 while the switch 6 is on (that is, V_{FC}=V_{B}), the output electric power P_{FC} of the fuel cell 2 becomes relatively large (see reference characters 63 and 64 in FIG. 3). On the other hand, when the voltage V_{B} becomes relatively high due to a large electric capacity of the rechargeable battery 3 while the switch 6 is on (that is, V_{FC}=V_{B}), the output electric power P_{FC} of the fuel cell 2 becomes relatively small (see reference characters 65 and 66 in FIG. 3). As described above, by directly connecting the fuel cell 2 and the rechargeable battery 3 as shown in FIG. 1 without interposing a DC/DC converter or the like between them, it is possible to obtain a reasonable output from the fuel cell 2 without performing special control.

When the fuel cell 2 is used, however, it has to be prevented from operating within an unstable operating region. FIG. 4 shows a stable operating region 67 and an unstable operating region 68 of the fuel cell 2. In this figure, there is an operating region (see FIG. 3) within which the output electric power P_{FC} sharply decreases with an increase in the current I_{FC}. Such an operating region corresponds to an unstable operating region 68.

If the fuel cell 2 is made to operate within the unstable operating region 68, degradation in performance of each single cell may be hastened, and, when the single cells are connected in series, voltages generated by these single cells may vary, causing polarity inversion (potential inversion). Thus, in the power supply device 1, appropriate control is performed so as to prevent the fuel cell 2 from operating within the unstable operating region 68.

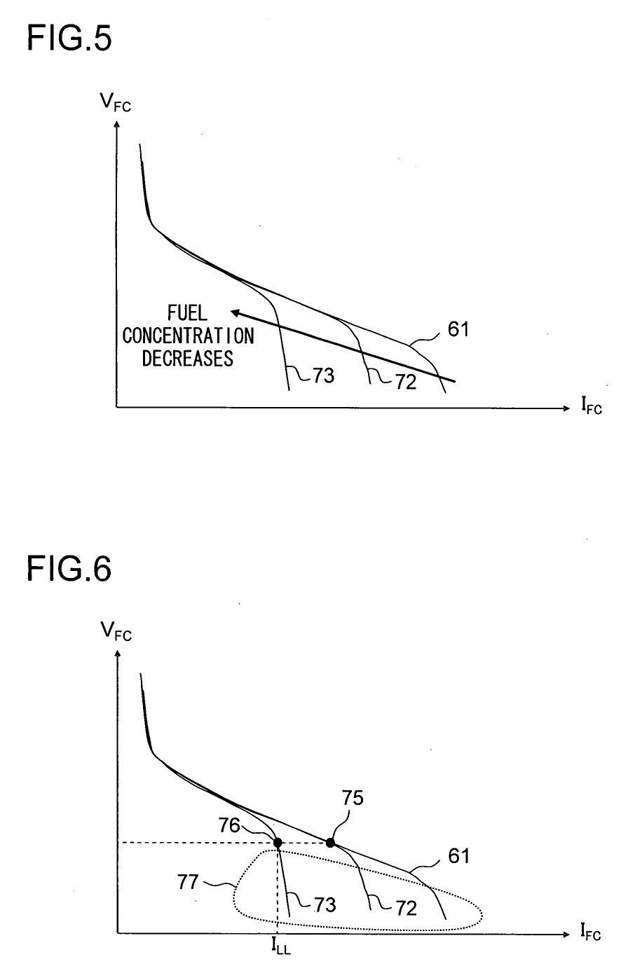

Curves 61, 72, and 73 shown in FIG. 5 indicate the relationships between the current I_{FC} and the voltage V_{FC} when the fuel concentrations are D1, D2, and D3, respectively. In this example, it is assumed that the inequality “D1>D2>D3” holds.

As will be understood from FIG. 5, when the voltage V_{FC} is kept constant, the current I_{FC} decreases with a decline in the fuel concentration associated with electric power generation by the fuel cell 2. On the other hand, when the switch 6 is on, the voltage V_{FC} automatically becomes equal to the voltage V_{B}. Thus, if the current I_{FC} is unconditionally permitted to decrease, there is a possibility that the operating point of the fuel cell 2 enters the unstable operating region.

In consideration of this possibility, when the detected current I_{FC} (more precisely, the current value of the current I_{FC}) becomes equal to or smaller than a predetermined lower limit current I_{LL} (more precisely, a value of the lower-limit current I_{LL}) while the switch 6 is on, the control circuit 4 turns the switch 6 off, thereby disconnecting the output terminals 2a and 3a.

For example, suppose that the fuel concentration of the fuel cell 2 is D1 or D2, and the operating point thereof is located at an operating point 75 shown in FIG. 6. The operating point 75, which can be considered as a normal operating point of the fuel cell 2 in the power supply device 1, is located within the stable operating region of the fuel cell 2. When the fuel concentration has decreased to D3 due to electric power generation, the operating point of the fuel cell 2 is shifted from the operating point 75 to a lower-limit operating point 76, with a decrease in the current I_{FC}. At the lower-limit operating point 76, the current I_{FC} and the lower limit current I_{LL} are equal to each other. The lower-limit operating point 76 is an operating point located near the border between the stable operating region and the unstable operating region (in FIG. 6, a region indicated by reference character 77). Note that, however, the lower-limit operating point 76 is located within the stable operating region of the fuel cell 2.

When the current I_{FC} becomes equal to or smaller than the lower limit current I_{LL}, the control circuit 4 judges that the fuel concentration becomes equal to or lower than a predetermined lower limit concentration (or judges that the fuel has run out), and turns the switch 6 off. This makes it possible to detect a decrease in concentration (or fuel exhaustion) without providing an additional concentration sensor or the like, and prevent the fuel cell 2 from operating within the unstable operating region.

The value of the lower limit current I_{LL} is, for example, a previously set constant value. Since the voltage V_{B} of the rechargeable battery 3 varies within a certain range, the above-described constant value is so set that the fuel cell 2 can operate within the stable operating region, even taking such variations in consideration.

The value of the lower limit current I_{LL} may be changed according to the detected voltage V_{B}. When the voltage V_{FC} (=V_{B}) is low, the operating point of the fuel cell 2 enters the unstable operating region even at a relatively large current value. Thus, when the detected voltage V_{B} is relatively low, the lower limit current I_{LL} is set to a relatively large value; when the detected voltage V_{B} is relatively high, the lower limit current I_{LL} is set to a relatively small value.

Next, restoration operation performed after the switch 6 is turned off as a result of the current I_{FC} becoming equal to or smaller than the lower limit current I_{LL} will be described. As described above, when the current I_{FC} becomes equal or smaller than the lower limit current I_{LL}, it can be judged that the fuel concentration has decreased to a lower limit concentration. Thus, the switch 6 should be kept off until fuel replenishment is confirmed.

The replenishment/replacement detecting circuit 8 detects whether the fuel cell 2 has been replenished with fuel or not. The detection result thus obtained is transmitted to the control circuit 4. When the switch 6 is turned off as a result of the current I_{FC} becoming equal to or smaller than the lower limit current I_{LL}, if a detection signal indicating that “the fuel cell 2 has been replenished with fuel” is transmitted from the replenishment/replacement detecting circuit 8 to the control circuit 4, the control circuit 4 turns the switch 6 on and thereby restores the connection between the output terminals 2a and 3a.

To put it the other way around, the output terminals 2a and 3a are kept disconnected until fuel replenishment is confirmed. This makes it possible to safely protect the fuel cell 2.

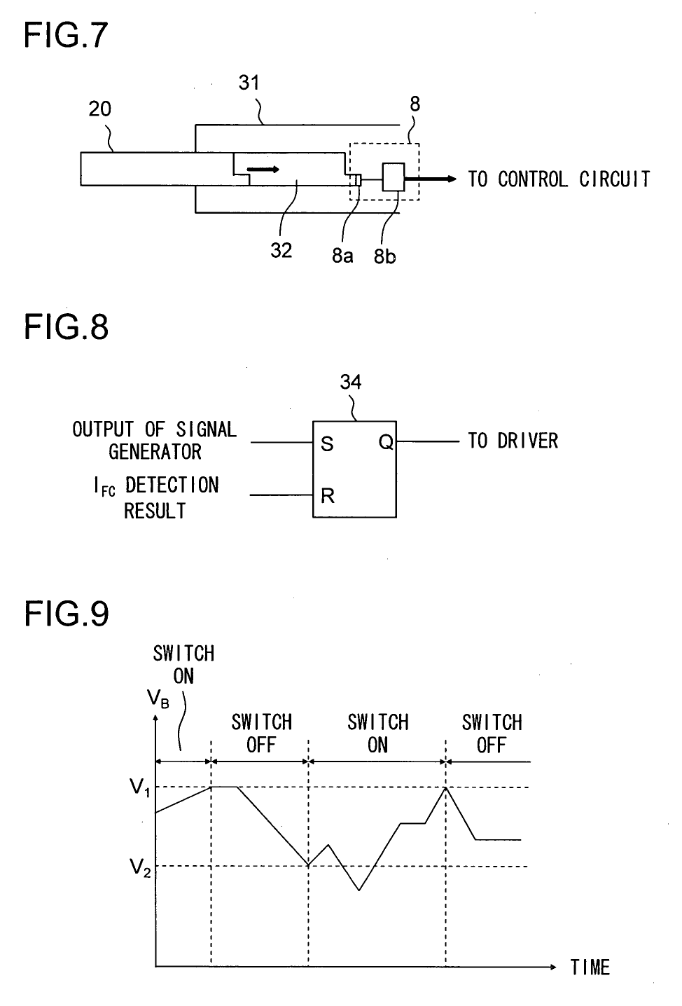

FIG. 7 is a sectional view showing a part of a portable device that is driven by using the power supply device 1 shown in FIG. 1. This portable device has a casing 31, inside which a space 32 for accommodating the fuel cartridge 20 is provided. By inserting the fuel cartridge 20 into the space 32, the fuel in the fuel cartridge 20 is fed to the fuel electrode 21 of the fuel cell 2. A switch portion 8a and a signal generator 8b form together the replenishment/replacement detecting circuit 8.

For example, when the switch 6 is turned off as a result of the current I_{FC} becoming equal to or smaller than the lower limit current I_{LL}, the user is notified of corresponding information as a message, for example, displayed on a display portion (not shown) of the portable device. Upon receipt of this notification, the user removes the fuel cartridge 20 from the space 32 and inserts a new fuel cartridge 20 into the space 32. When the fuel cartridge 20 is inserted into the space 32, the switch portion 8a fixed to the end face of the space 32 receives pressure from the tip of the fuel cartridge 20, whereby the switch portion 8a is shifted from an off state to an on state. At the same time (or at about the same time), the fuel electrode 21 is fed with fuel from the fuel cartridge 20 newly accommodated in the space 32.

The signal generator 8b detects an edge at the moment at which the switch portion 8a is turned on. Upon detecting such an edge, the signal generator 8b generates a pulse whose potential takes a high level for a given period of time. This pulse, which corresponds to the above-described detection signal indicating that “the fuel cell 2 has been replenished with fuel”, is transmitted to the control circuit 4. An output signal of the signal generator 8b is generally kept at a low level. By configuring the replenishment/replacement detecting circuit 8 as described above, it is possible to generate the detection signal described above only when the fuel cartridge 20 is replaced.

FIG. 8 shows an example of the configuration of the control circuit 4. The control circuit 4 is composed of a flip-flop (latch circuit) 34 shown in FIG. 8. The set terminal (S) of the flip-flop 34 is fed with an output signal of the signal generator 8b, and the reset terminal (R) thereof is fed with a signal corresponding to the detection result of the current detector 5. A low level signal is usually fed to the reset terminal (R). When I_{FC}≦I_{LL}, a high level signal is fed to the reset terminal (R) for a given period of time.

When the set terminal (S) is fed with a high level signal, the output signal from the output terminal (Q) of the flip-flop 34 takes a high level. The output signal remains at a high level until the reset terminal (R) is fed with a next high level signal. When the reset terminal (R) is fed with a high level signal, the output signal from the output terminal (Q) of the flip-flop 34 takes a low level. The output signal remains at a low level until the set terminal (S) is fed with a next high level signal. The output signal from the output terminal (Q) of the flip-flop 34 is fed to a driver (for example, an FET driver) of the switch 6 (for example, an FET) as a signal for controlling on/off of the switch 6.

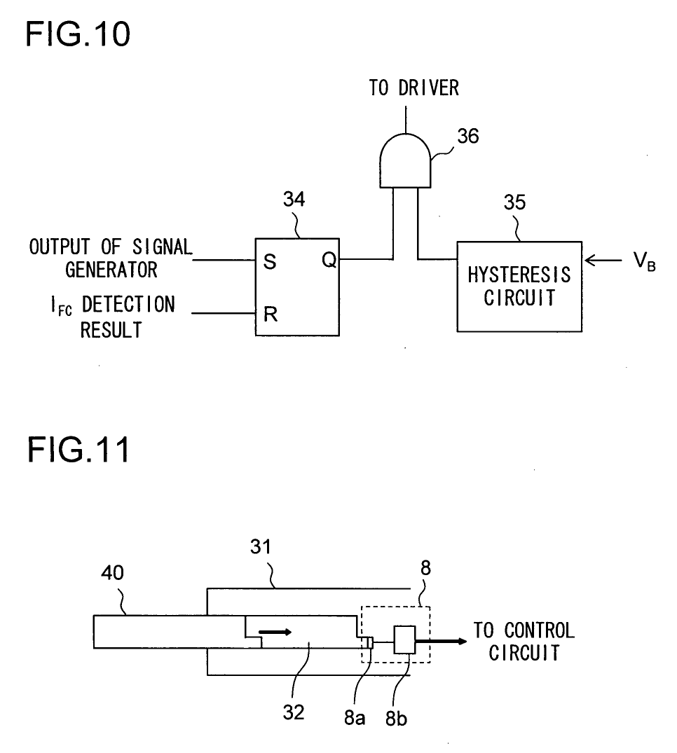

When the output signal from the output terminal (Q) takes a high level, the switch 6 is turned on; when the output signal from the output terminal (Q) takes a low level, the switch 6 is turned off (however, there is an exception, which will be described later with reference to FIG. 10).

Incidentally, a confirmation switch (not shown) or the like may be provided inside the power supply device 1 or in a portable device that is driven by using the power supply device 1. In this case, the replenishment/replacement detecting circuit 8 is composed of this confirmation switch. At the time of replacement of the fuel cartridge 20, the user performs predetermined operation for the confirmation switch. Based on a signal generated in response to this operation, the control circuit 4 recognizes that “the fuel cell 2 has been replenished with fuel” and shifts the switch 6 from an off state to an on state.

When the switch 6 is on, the rechargeable battery 3 is charged by the fuel cell 2, depending on how heavy the load 9 is. On the other hand, the rechargeable battery 3 has to be prevented from being overcharged. Thus, when the voltage V_{B} becomes equal to or higher than a predetermined upper limit voltage V₁ (for example, 4.1 V) (more precisely, when the voltage value of the voltage V_{B} becomes equal to or larger than a predetermined upper-limit voltage value V₁) while the switch 6 is on, the control circuit 4 turns the switch 6 off so as to prevent the rechargeable battery 3 from being overcharged.

The rechargeable battery 3 (for example, a lithium-ion rechargeable battery) has a drawback that its lifespan is reduced if it is repeatedly charged/discharged in an almost fully charged state. In consideration of this drawback, as shown in FIG. 9, after the switch 6 is turned off as a result of the voltage V_{B} becoming equal to or higher than the upper limit voltage V₁, the control circuit 4 keeps the switch 6 off until the voltage V_{B} becomes equal to or lower than a lower limit voltage V₂ (for example, 3.8 V) (more precisely, until the voltage value of the voltage V_{B} becomes equal to or smaller than a lower-limit voltage value V₂). When the voltage V_{B} becomes equal to or lower than the lower limit voltage V₂, the switch 6 is switched from off to on. As a result, the fuel cell 2 resumes charging the rechargeable battery 3. The switch 6 is kept on until the voltage V_{B} becomes equal to or higher than the upper limit voltage V₁ again. Here, the relationship V₁>V₂ holds.

As described above, introducing hysteresis in the charging control of the rechargeable battery 3 reduces the number of charge/discharge cycles of the rechargeable battery 3 in an almost fully charged state. This helps prolong the lifespan of the rechargeable battery 3. Furthermore, when the voltage V_{B} decreases, the switch 6 is automatically turned on. This permits the power supply device 1 to stably feed electric power.

FIG. 10 shows an example of the configuration of the control circuit 4 that also performs on/off control of the switch 6 according to the voltage V_{B}. According to the voltage V_{B}, a hysteresis circuit 35 outputs a high level output signal when the switch 6 has to be turned on and outputs a low level output signal when the switch 6 has to be turned off. Only when both an output signal from the output terminal (Q) of the flip-flop 34 and an output signal from the hysteresis circuit 35 take a high level, an AND circuit 36 controls a driver (for example, an FET driver) of the switch 6 (for example, an FET) in such a way that the switch 6 is turned on. When at least one of the output signal from the output terminal (Q) of the flip-flop 34 and the output signal from the hysteresis circuit 35 takes a low level, the switch 6 is turned off.

### MODIFIED EXAMPLES

Although the descriptions heretofore deal solely with a configuration in which the fuel cartridge 20 is made attachable to and detachable from the fuel cell 2 so that the fuel cartridge 20 can be replaced when the fuel concentration decreases, it is also possible to adopt various other methods as long as the fuel concentration can be restored.

For example, a fuel cartridge and a fuel cell (a fuel cell body) may be integrated together into a single fuel cell unit, so that the entire fuel cell unit is replaced when the fuel concentration decreases. In this case, the fuel cell unit (hereinafter referred to as the fuel cell unit 40) is built with a fuel cell 2 (a fuel cell body) composed of a fuel electrode 21, an oxygen electrode 22, and a solid polymer electrolyte membrane 23, which are shown in FIG. 2, and a fuel cartridge 20.

As shown in FIG. 11, the entire fuel cell unit 40 is so configured that it can be inserted into and removed from a space 32 of a casing 31. By inserting the fuel cell unit 40 into the space 32, electric power generation by the fuel cell 2 of the fuel cell unit 40 is made possible, and the fuel cell 2 of the fuel cell unit 40 is electrically connected between the ground line GND and the switch 6 as described above (see FIG. 1).

For example, when the switch 6 is turned off as a result of the current I_{FC} becoming equal to or smaller than the lower limit current I_{LL}, the user is notified of corresponding information as a message, for example, displayed on a display portion (not shown) of the portable device. Upon receipt of this notification, the user removes the fuel cell unit 40 from the space 32 and inserts a new fuel cell unit 40 into the space 32. When the fuel cell unit 40 is inserted into the space 32, a switch portion 8a fixed to the end face of the space 32 receives pressure from the tip of the fuel cell unit 40, whereby the switch portion 8a is shifted from an off state to an on state. At the same time (or at about the same time), electric power generation by the fuel cell unit 40 newly accommodated in the space 32 is made possible.

When recognizing that, via the switch portion 8a and the signal generator 8b, the fuel cell unit 40 has been replaced, the control circuit 4 shifts the switch 6 from an off state to an on state. Additionally, the confirmation switch described above (not shown) may be provided. At the time of replacement of the fuel cell unit 40, the user performs predetermined operation for the confirmation switch. Based on a signal generated in response to this operation, the control circuit 4 recognizes that “the fuel cell unit 40 has been replaced” and shifts the switch 6 from an off state to an on state.

Although the descriptions heretofore deal with a rechargeable battery as an example of an electric storage device connected in parallel to a fuel cell, it is also possible to adopt a capacitor as an electric storage device.

What is claimed is:

1. A hybrid power supply device, comprising:
a fuel cell;
an electric storage device that is connected in parallel to the fuel cell via a switch; and
a control circuit that controls connection between output terminals of the fuel cell and the electric storage device by controlling on/off of the switch, wherein
the control circuit controls the connection between the output terminals based on an output current of the fuel cell, and
disconnects the output terminals when the output current of the fuel cell becomes equal to or smaller than a predetermined lower limit current while the output terminals are connected.

2. The hybrid power supply device of claim 1, further comprising:
a voltage detector that detects an output voltage of the electric storage device, wherein
the lower limit current is determined in accordance with the output voltage of the electric storage device.

3. The hybrid power supply device of claim 1, further comprising:
a replenishment detecting portion that detects whether the fuel cell is replenished with fuel or not, wherein
when fuel replenishment is detected after the output terminals are disconnected as a result of the output current of the fuel cell becoming equal to or smaller than the lower limit current, the control circuit restores the connection between the output terminals.

4. The hybrid power supply device of claim 1, wherein
the hybrid power supply device is so configured that a fuel cell unit built with the fuel cell and fuel for the fuel cell can be replaced,
the hybrid power supply device further comprises a replacement detecting portion that detects whether the fuel cell unit is replaced or not, and
when replacement of the fuel cell unit is detected after the output terminals are disconnected as a result of the output current of the fuel cell becoming equal to or smaller than the lower limit current, the control circuit restores the connection between the output terminals.

5. The hybrid power supply device of claim 1, further comprising:
a voltage detector that detects an output voltage of the electric storage device, wherein
the control circuit disconnects the output terminals when the detected output voltage becomes equal to or higher than a predetermined first voltage while the output terminals are connected.

6. The hybrid power supply device of claim 1, further comprising:
a voltage detector that detects an output voltage of the electric storage device, wherein
when the detected output voltage becomes equal to or higher than a predetermined first voltage while the output terminals are connected, the control circuit disconnects the output terminals, and then, when the detected output voltage becomes equal to or lower than a predetermined second voltage that is lower than the first voltage, the control circuit restores the connection between the output terminals.

7. A hybrid power supply device, comprising:
a fuel cell;
an electric storage device that is connected in parallel to the fuel cell via a switch;
a control circuit that controls connection between output terminals of the fuel cell and the electric storage device by controlling on/off of the switch; and
a voltage detector that detects an output voltage of the electric storage device, wherein
when the detected output voltage becomes equal to or higher than a predetermined first voltage while the output terminals are connected, the control circuit disconnects the output terminals, and then, when the detected output voltage becomes equal to or lower than a predetermined second voltage that is lower than the first voltage, the control circuit restores the connection between the output terminals.
